(19) United States
(12) Patent Application Publication
(10) Pub. No.: US 2012/0233407 A1
(43) Pub. Date: Sep. 13, 2012

(54) CACHE PHASE DETECTOR AND PROCESSOR CORE

(76) Inventors: Ju-Hee CHOI, Seoul (KR); Hoi-Jin Lee, Seoul (KR)

(21) Appl. No.: 13/411,728

(22) Filed: Mar. 5, 2012

(30) Foreign Application Priority Data
Mar. 7, 2011 (KR) 10-2011-0019766

(51) Int. Cl. G06F 12/08

(52) U.S. Cl. 711/122; 711/118; 711/125; 711/E12.02; 711/E12.024

(57) ABSTRACT

A cache phase detector included in a processor core according to example embodiments includes a counting unit and a signal generating unit. The counting unit generates a critical section miscount by counting a request from the processor core resulting in a tag miss and a valid cache line based on a tag miss signal and a cache line valid signal. The signal generating unit compares the critical section miscount from the counting unit with a reference value, and generates a cache phase change signal if the critical section miscount is greater than the reference value.

### CROSS-REFERENCE TO RELATED APPLICATIONS

Korean Patent Application No. 2011-0019766, filed on Mar. 7, 2011, in the Korean Intellectual Property Office, and entitled:“Cache Phase Detector and Process Core,” is incorporated by reference herein in its entirety.

### BACKGROUND

1. Technical Field

Exemplary embodiments relate to processors. More particularly, exemplary embodiments relate to cache phase detectors and processor cores.

2. Description of the Related Art

A processor uses a cache memory to reduce a memory access time. The cache memory may store frequently used instructions and/or data from a main memory, and the processor may fetch the instructions and/or the data from the cache memory having a short access latency instead of the main memory having a long access latency, thereby reducing the memory access time of the processor.

### SUMMARY

One or more embodiments provide a cache phase detector to efficiently use a critical section cache;

One or more embodiments provide a processor core capable of reducing power consumption.

One or more embodiments provide a cache phase detector and a processor core that may increase a hit rate of a critical section cache.

One or more embodiments provide a cache phase detector and a processor core that may efficiently use a critical section cache having a small size, thereby reducing power consumption.

One or more embodiments provide a cache phase detector included in a multi-core processor including a counting unit and a signal generating unit. The counting unit generates a critical section miscount by counting a request from the processor core resulting in a tag miss and a valid cache line based on a tag miss signal and a cache line valid signal. The tag miss signal indicates that a tag corresponding to the request does not exist in a critical section cache, and the cache line valid signal indicates that a cache line of the critical section cache corresponding to the request is valid. The signal generating unit compares the critical section miscount from the counting unit with a reference value, and generates a cache phase change signal if the critical section miscount is greater than the reference value. The cache phase change signal indicates that a cache phase of a critical section performed by the processor core is changed.

In some embodiments, the counting unit may receive a critical section entrance signal indicating that the processor core enters the critical section from a critical section detector included in the processor core, and initializes the critical section miscount in response to the critical section entrance signal.

In some embodiments, the counting unit may include an AND gate configured to perform an AND operation on the tag miss signal and the cache line valid signal, and the counter configured to increase the critical section miscount in response to an output signal of the AND gate.

In some embodiments, the signal generating unit may include a register configured to store the reference value, and a comparator configured to generate the cache phase change signal by comparing the critical section miscount from the counting unit with the reference value from the register.

In one or more embodiments, a processor core included in a multi-core processor includes a first-level data cache, a critical section data cache and a data cache selecting device. The critical section data cache has a size smaller than that of the first-level data cache. The data cache selecting device generates a data critical section miscount by counting a data request from the processor core resulting in a tag miss and a valid cache line, determines a data cache phase of a critical section based on the data critical section miscount, and selects, as a data cache to be accessed by the processor core, the critical section data cache or the first-level data cache according to the determined data cache phase.

In some embodiments, the processor core may check whether a valid data corresponding to the data request exists in the critical section data cache if the critical section data cache is selected by the data cache selecting device. The processor core may fetch the valid data from the critical section data cache if the valid data exists in the critical section data cache, and may fetch the valid data from the first-level data cache, another cache or a main memory if the valid data does not exist in the critical section data cache.

In some embodiments, the processor core may check whether a valid data corresponding to the data request exists in the first-level data cache if the first-level data cache is selected by the data cache selecting device. The processor core may fetch the valid data from the first-level data cache if the valid data exists in the first-level data cache, and may fetch the valid data from another cache or a main memory if the valid data does not exist in the first-level data cache.

In some embodiments, the data cache selecting device may include a data cache phase detector configured to generate the data critical section miscount by counting the data request resulting in the tag miss and the valid cache line based on a data tag miss signal and a data cache line valid signal, and configured to generate a data cache phase change signal based on the data critical section miscount, the data cache phase change signal indicating that the data cache phase of the critical section is changed, and a data cache selector configured to determine the data cache phase of the critical section based on the data cache phase change signal, and configured to select the critical section data cache or the first-level data cache according to the determined data cache phase.

In some embodiments, the processor core may further include a first-level instruction cache, a critical section instruction cache having a size smaller than that of the first-level instruction cache, and an instruction cache selecting device configured to generate an instruction critical section miscount by counting an instruction request from the processor core resulting in a tag miss and a valid cache line, configured to determine an instruction cache phase of the critical section based on the instruction critical section miscount, and configured to select, as an instruction cache to be accessed by the processor core, the critical section instruction cache or the first-level instruction cache according to the determined instruction cache phase.

In some embodiments, the processor core may check whether a valid instruction corresponding to the instruction request exists in the critical section instruction cache if the critical section instruction cache is selected by the instruction cache selecting device. The processor core may fetch the valid instruction from the critical section instruction cache if the valid instruction exists in the critical section instruction cache, and may fetch the valid instruction from the first-level instruction cache, another cache or a main memory if the valid instruction does not exist in the critical section instruction cache.

In some embodiments, the processor core may check whether a valid instruction corresponding to the instruction request exists in the first-level instruction cache if the first-level instruction cache is selected by the instruction cache selecting device. The processor core may fetch the valid instruction from the first-level instruction cache if the valid instruction exists in the first-level instruction cache, and may fetch the valid instruction from another cache or a main memory if the valid instruction does not exist in the first-level instruction cache.

In some embodiments, the processor core may further include a critical section detector configured to generate a critical section entrance signal by detecting that the processor core enters the critical section, and configured to provide the critical section entrance signal to the data cache selecting device and the instruction cache selecting device.

In some embodiments, the processor core may further include a second-level cache having a size greater than those of the first-level data cache and the first-level instruction cache. The processor core may access the second-level cache if a valid data corresponding to the data request exists neither in the critical section data cache nor in the first-level data cache, and may access the second-level cache if a valid instruction corresponding to the instruction request exists neither in the critical section instruction cache nor in the first-level instruction cache.

In some embodiments, the processor core may further include a first-level instruction cache, a filter cache having a size smaller than that of the first-level instruction cache, and a predictor configured to select, as an instruction cache to be accessed by the processor core, the filter cache or the first-level instruction cache by predicting whether a valid instruction corresponding to an instruction request from the processor core exists in the filter cache.

In some embodiments, the processor core may check whether the valid instruction exists in the filter cache if the filter cache is selected by the predictor. The processor core may fetch the valid instruction from the filter cache if the valid instruction exists in the filter cache, and may fetch the valid instruction from the first-level instruction cache, another cache or a main memory if the valid instruction does not exist in the filter cache.

One or more embodiments provide a critical section cache selector included in a processor core including a critical section cache and at least one n-level cache, the cache selector including a cache phase detector configured to determine a cache phase of the critical section cache based on a critical section miss signal generated based on tag miss signals and valid cache line signals generated in response to requests from the processor core, and to select the critical section cache or the at least one n-level cache based on the critical section miss signal, where n is an integer greater than or equal to 1.

In some embodiments, the critical section cache may be a critical section data cache and each of the n-level caches is an n-level data cache.

In some embodiments, the critical section cache may be a critical section instruction cache and each of the n-level caches is an n-level instruction cache.

In some embodiments, the cache phase detector may include a counter configured to generate the critical section miss signal by counting respective ones of the requests from the processor core resulting in the tag miss and the valid cache line signals.

In some embodiments, the cache phase detector may be configured to compare the critical section miss signal with a reference signal, and to generate a cache phase change signal indicating that a phase of the critical section cache is changed if the critical section miss signal has a value greater than a value of the reference signal.

### BRIEF DESCRIPTION OF THE DRAWINGS

Features will become apparent to those of ordinary skill in the art by describing in detail exemplary embodiments with reference to the attached drawings, in which

FIG. 1 illustrates a block diagram of an exemplary embodiment of a cache phase detector;

FIG. 2 illustrates a flow chart of an exemplary embodiment of a method of operating a cache phase detector of FIG. 1;

FIG. 3 illustrates a block diagram of an exemplary embodiment of a processor core;

FIG. 4 illustrates a flow chart of an exemplary embodiment of a method of fetching an instruction in a processor core of FIG. 3;

FIG. 5 illustrates a flow chart of an exemplary embodiment of a method of fetching data in a processor core of FIG. 3;

FIG. 6 illustrates a block diagram of another exemplary embodiment of a processor core;

FIG. 7 illustrates a flow chart of an exemplary embodiment of a method of fetching an instruction in a processor core of FIG. 6;

FIG. 8 illustrates a block diagram of an exemplary embodiment of a multi-core processor;

FIG. 9 illustrates a block diagram of an exemplary embodiment of a multi-core processor;

FIG. 10 illustrates a block diagram of an exemplary embodiment of a mobile system;

FIG. 11 illustrates a block diagram of an exemplary embodiment of a computing system.

### DETAILED DESCRIPTION

Various exemplary embodiments will be described more fully hereinafter with reference to the accompanying drawings, in which some example embodiments are shown. The present inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

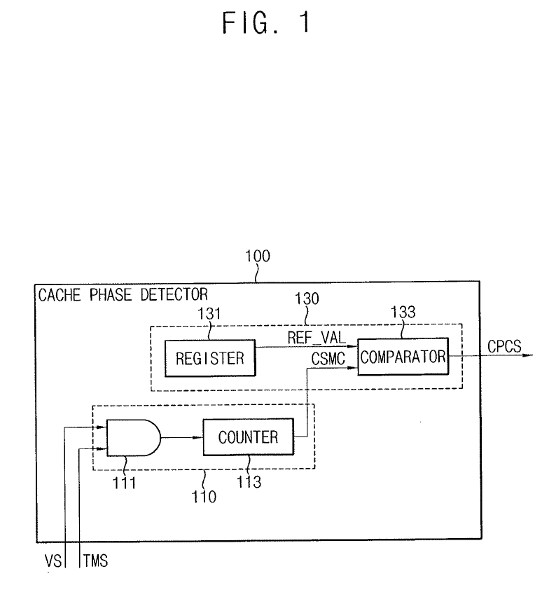

FIG. 1 illustrates a block diagram of an exemplary embodiment of a cache phase detector 100.

Referring to FIG. 1, the cache phase detector 100 may include a counting unit 110 and a signal generating unit 130. The cache phase detector 100 may be included in a processor core having a critical section instruction/data cache and a first-level instruction/data cache.

The counting unit 110 may receive a tag miss signal TMS and a cache line valid signal VS from the critical section instruction/data cache, and may generate a critical section miscount CSMC by counting a request resulting in a tag miss and a valid cache line based on the tag miss signal TMS and the cache line valid signal VS. Here, the tag miss signal TMS indicates that a tag corresponding to the request does not exist in the critical section instruction/data cache. That is, the tag miss signal TMS indicates that that tag miss occurs at the critical section instruction/data cache. The cache line valid signal VS indicates that a cache line of the critical section instruction/data cache corresponding to the request is valid. That is, the cache line valid signal VS indicates a valid cache line corresponding to the request exists in the critical section instruction/data cache.

For example, if the processor core enters a critical section, and generates a request to execute data, the processor core may first access a critical section data cache. If a tag corresponding to the request (e.g., a tag that is the same as most significant bits (MSBs) of an address of the data to be executed) does not exist in the critical section data cache (i.e., if the request results in the tag miss at the critical section data cache), the critical section data cache may provide the counting unit 110 with the tag miss signal TMS of a high level. If a cache line corresponding to the request (e.g., a cache line having an index that is the same as least significant bits (LSBs) of the address of the data to be executed) has a valid bit of a predetermined value (e.g., “1”) indicating that the cache line is valid (i.e., if the request results in the valid cache line at the critical section data cache), the critical section data cache may provide the counting unit 110 with the cache line valid signal VS of a high level. That is, in case of the tag miss and the valid cache line, the tag miss signal TMS and the cache line valid signal VS may have high levels.

If the processor core enters the critical section, the processor core may execute a program code or a program flow including an instruction/data corresponding to the critical section, and the critical section instruction/data cache may store the instruction/data corresponding to the critical section. After that, if the processor core executes another program code, the critical section instruction/data cache may output the tag miss signal TMS of a high level and the cache line valid signal VS of a high level in response to a request for the instruction/data corresponding to the critical section, and the counting unit 110 may increase the critical section miscount CSMC based on the tag miss signal TMS and the cache line valid signal VS. Here, after a processor core enters a critical section, the processor core may execute a program code other than a program code corresponding to the critical section, which may be referred to as a change of a “cache phase” of the critical section. That is, the cache phase of the critical section may be determined to be changed if the processor core executes the program code not corresponding to the critical section.

In some example embodiments, the counting unit 110 may include an AND gate 111 and a counter 113. The AND gate 111 may receive the tag miss signal TMS and the cache line valid signal VS, and may perform an AND operation on the tag miss signal TMS and the cache line valid signal VS. The counter 113 may increase the critical section miscount CSMC in response to an output signal of the AND gate 111. The counter 113 may receive a critical section entrance signal indicating that the processor core enters the critical section from a critical section detector included in the processor core, and may initialize the critical section miscount CSMC in response to the critical section entrance signal.

The signal generating unit 130 may receive the critical section miscount CSMC from the counting unit 110, and may generate a cache phase change signal CPCS based on the critical section miscount CSMC. Here, the cache phase change signal CPCS indicates that the cache phase of the critical section performed by the processor core is changed.

As described above, if the processor core executes the program code not corresponding to the critical section after the processor core enters the critical section (i.e., if the cache phase of the critical section is changed), the critical section miscount CSMC may be increased. The signal generating unit 130 may generate the cache phase change signal CPCS indicating the change of the cache phase of the critical section based on the increased critical section miscount CSMC. If the processor core receives the cache phase change signal CPCS, the processor core may access the first-level instruction/data cache without accessing the critical section instruction/data cache. That is, the processor core may first access the critical section instruction/data cache before the cache phase of the critical section is changed, and may first access the first-level instruction/data cache after the cache phase of the critical section is changed. Since an instruction/data corresponding to the request may be stored in the critical section instruction/data cache before the cache phase of the critical section is changed, and may not be stored in the critical section instruction/data cache after the cache phase of the critical section is changed, the processor core may access first the critical section instruction/data cache while the instruction/data corresponding to the request is stored in the critical section instruction/data cache. As described above, since the cache phase detector 100 may accurately detect the change of the cache phase of the critical section, the processor core including the cache phase detector 100 according to example embodiments may efficiently use the critical section instruction/data cache.

In some example embodiments, the signal generating unit 130 may include a register 131 and a comparator 133. The register 131 may store a reference value REF_VAL. For example, the reference value REF_VAL may be determined according to a size of the critical section instruction/data cache, a characteristic of a program code corresponding to the critical section, or the like. The comparator 133 may receive the reference value REF_VAL from the register 131, may receive the critical section miscount CSMC from the counter 113, and may generate the cache phase change signal CPCS by comparing the critical section miscount CSMC with the reference value REF_VAL. For example, if the critical section miscount CSMC is greater than the reference value REF_VAL, the comparator 133 may generate the cache phase change signal CPCS of a high level.

As described above, in one or more embodiments, a cache phase detector, e.g., 100, may efficiently detect whether a processor core executes a program code that does not corresponding to the critical section, or whether the cache phase of the critical section has changed. A processor core including the cache phase detector 100 may selectively access the critical section instruction/data cache based on the cache phase of the critical section determined by the cache phase detector 100. Accordingly, a hit rate of the critical section instruction/data cache may be improved. Further, since the critical section instruction/data cache having a relatively small size may be efficiently used, power consumption of a system including the processor core may be reduced.

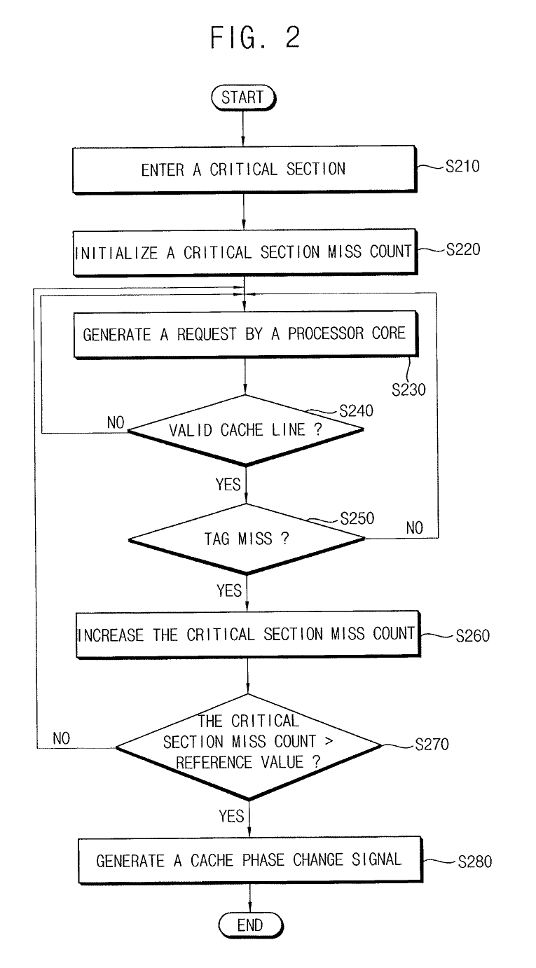

FIG. 2 illustrates a flow chart of an exemplary embodiment of a method of operating the cache phase detector 100 of FIG. 1.

Referring to FIGS. 1 and 2, if a processor core enters a critical section (S210), a critical section detector included in the processor core may generate a critical section entrance signal. The cache phase detector 100 included in the processor core may receive the critical section entrance signal from the critical section detector. The counter 113 may initialize a critical section miscount CSMC in response to the critical section entrance signal, and may perform a counting operation (S220).

The processor core may generate a request for an instruction/data, and may access a critical section instruction/data cache (S230). If a cache line corresponding to the request is invalid (S240:NO) or if a tag corresponding to the request exists in the critical section instruction/data cache (S250:NO), the counter 113 may not increase the critical section miscount CSMC. For example, the critical section instruction/data cache may generate a cache line valid signal VS of a low level if the cache line corresponding to the request is invalid, and may generate a tag miss signal TMS of a low level if the tag corresponding to the request exists in the critical section instruction/data cache. The AND gate 111 may output an output signal of a low level if the cache line valid signal VS has a low level or if the tag miss signal TMS has a low level. If the counter 113 receives the output signal of a low level, the counter 113 may not increase the critical section miscount CSMC.

If the cache line corresponding to the request is valid (S240:YES) and if the tag corresponding to the request does not exist in the critical section instruction/data cache (S250:YES), the counter 113 may increase the critical section miscount CSMC (S260). For example, the critical section instruction/data cache may generate the cache line valid signal VS of a high level if the cache line corresponding to the request is valid, and may generate the tag miss signal TMS of a high level if the tag corresponding to the request does not exist in the critical section instruction/data cache. If the cache line valid signal VS and the tag miss signal TMS have high levels, the AND gate 111 may output the output signal of a high level, and the counter 113 may increase the critical section miscount CSMC in response to the output signal of the high level. The cache line valid signal VS and the tag miss signal TMS may have high levels when the processor core executes a program code not corresponding to the critical section.

The comparator 133 may compare the critical section miscount CSMC with a reference value REF_VAL stored in a register 131 (S270). If the critical section miscount CSMC is less than or equal to the reference value REF_VAL (S270:NO), it is determined that a cache phase of the critical section is not changed, and the processor core may continue to access the critical section instruction/data cache.

If the critical section miscount CSMC becomes greater than the reference value REF_VAL (S270:YES), the comparator 133 may generate a cache phase change signal CPCS indicating that the cache phase of the critical section is changed (S280). After the processor core receives the cache phase change signal CPCS, the processor core may access a first-level instruction/data cache without accessing the critical section instruction/data cache.

As described above, one or more embodiments of a cache phase detector, e.g., 100, may accurately determine a cache phase of a critical section, and a processor core may selectively access the critical section instruction/data cache based on the determined cache phase. Accordingly, the critical section instruction/data cache may be efficiently used, and power consumption of a system including the processor core may be reduced.

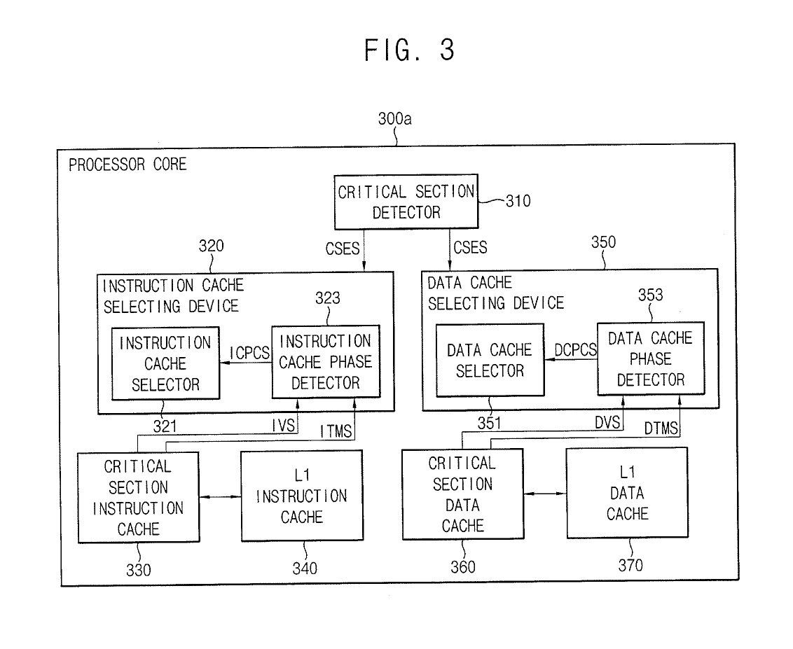

FIG. 3 illustrates a block diagram of an exemplary embodiment of a processor core 300a.

Referring to FIG. 3, the processor core 300a may include a critical section detector 310, an instruction cache selecting device 320, a critical section instruction cache 330, a first-level L1 instruction cache 340, a data cache selecting device 350, a critical section data cache 360, and a first-level L1 data cache 370. In some embodiments, the processor core 300a may be included in a multi-core processor having a plurality of processor cores.

The critical section detector 310 may detect that the processor core 300a enters a critical section and/or that the processor core 300a leaves the critical section. For example, the critical section detector 310 may generate a critical section entrance signal CSES by detecting an entrance to the critical section, and may provide the critical section entrance signal CSES to the instruction cache selecting device 320 and the data cache selecting device 350. The critical section detector 310 may further generate a critical section leave signal by detecting an exit from the critical section, and may provide the critical section leave signal to the instruction cache selecting device 320 and the data cache selecting device 350.

The instruction cache selecting device 320 may receive the critical section entrance signal CSES, and may select the critical section instruction cache 330 or the first-level instruction cache 340 as an instruction cache to be accessed by the processor core 300a. In some embodiments, if the processor core 300a enters the critical section, the instruction cache selecting device 320 may generate an instruction critical section miscount by counting an instruction request resulting in a tag miss and a valid cache line, and may determine an instruction cache phase of the critical section based on the instruction critical section miscount. The instruction cache selecting device 320 may select the critical section instruction cache 330 or the first-level instruction cache 340 based on the determined instruction cache phase of the critical section.

The instruction cache selecting device 320 may include an instruction cache phase detector 323 and an instruction cache selector 321. The instruction cache phase detector 323 may receive an instruction tag miss signal ITMS and an instruction cache line valid signal IVS from the critical section instruction cache 330, and may increase the instruction critical section miscount when both the instruction tag miss signal ITMS and the instruction cache line valid signal IVS have high levels. The instruction cache phase detector 323 may generate an instruction cache phase change signal ICPCS indicating that the instruction cache phase of the critical section is changed if the instruction critical section miscount is greater than a reference value.

If a tag corresponding to the instruction request does not exist in the critical section instruction cache 330 (i.e., in case of a tag miss) or if a cache line corresponding to the instruction request is invalid (i.e., in case of an invalid cache line), a cache miss occurs at the critical section instruction cache 330. In the multi-core processor, a cache line stored in the critical section instruction cache 330 of the processor core 300a may be invalidated by another processor core, and an instruction request for an instruction included in the invalid cache line may result in the cache miss although a tag corresponding to the instruction request exists in the critical section instruction cache 330. This cache miss caused by the invalid cache line may occur although the processor core 300a executes a program code corresponding to the critical section. Thus, when the cache miss caused by the invalid cache line occurs, the instruction cache phase of the critical section may be determined not to be changed. In a case where a tag corresponding to an instruction request does not exist in the critical section instruction cache 330, the cache miss may occur although a cache line corresponding to the instruction request is valid. This cache miss caused by the tag miss may occur when the processor core 300a executes a program code not corresponding to the critical section. Thus, when the cache miss caused by the tag miss occurs, the instruction cache phase of the critical section may be determined to be changed. In one or more embodiments, the instruction cache phase detector 323 may count the instruction request resulting in the tag miss and the valid cache line based on the instruction tag miss signal ITMS and the instruction cache line valid signal IVS, thereby accurately detecting the change of the instruction cache phase of the critical section.

The instruction cache selector 321 may select the critical section instruction cache 330 as the instruction cache to be accessed by the processor core 300a in response to the critical section entrance signal CSES. For example, if the critical section instruction cache 330 is selected by the instruction cache selector 321, the processor core 300a may check whether a valid instruction corresponding to the instruction request exists in the critical section instruction cache 330. If the valid instruction exists in the critical section instruction cache 330 (i.e., in case of a tag hit and a valid cache line), the processor core 300a may fetch the instruction from the critical section instruction cache 330. If the valid instruction does not exist in the critical section instruction cache 330 (i.e., in case of a tag miss or an invalid cache line), the processor core 300a may fetch the instruction from the first-level instruction cache 340, another cache (e.g., a second-level cache or a third-level cache), or a main memory. In some embodiments, if the valid instruction does not exist in the critical section instruction cache 330 and instead exists in the first-level instruction cache 340, a cache line including the valid instruction in the first-level instruction cache 340 may be copied to the critical section instruction cache 330, or may be exchanged for a cache line (e.g., a least used cache line) of the critical section instruction cache 330. Thereafter, the processor core 300a may fetch the instruction from the critical section instruction cache 330.

The critical section instruction cache 330 may have a size smaller than that of the first-level instruction cache 340, and may store instructions corresponding to the critical section. The instructions corresponding to the critical section may be repeatedly executed with a temporal locality. Accordingly, after the processor core 300a enters the critical section, the processor core 300a may use the critical section instruction cache 330 storing the instructions having the temporal locality, thereby increasing a hit rate for the instruction requests from the processor core 300a. Further, since the processor core 300a may use the critical section instruction cache 330 having the size smaller than that of the first-level instruction cache 340, power consumption of the processor core 300a may be reduced. In some embodiments, the critical section instruction cache 330 may store the instructions as they are stored in the main memory. In some other embodiments, the critical section instruction cache 330 may store fetched or decoded instructions.

If the instruction cache phase of the critical section is changed, the instruction cache selector 321 may receive the instruction cache phase change signal ICPCS from the instruction cache phase detector 323, and may select the first-level instruction cache 340 as the instruction cache to be accessed by the processor core 300a. For example, if the first-level instruction cache 340 is selected by the instruction cache selector 321, the processor core 300a may check whether the valid instruction corresponding to the instruction request exists in the first-level instruction cache 340. If the valid instruction exists in the first-level instruction cache 340 (i.e., in case of a tag hit and a valid cache line), the processor core 300a may fetch the instruction from the first-level instruction cache 340. If the valid instruction does not exist in the first-level instruction cache 340 (i.e., in case of a tag miss or an invalid cache line), the processor core 300a may fetch the instruction from another cache (e.g., the second-level cache or the third-level cache) or the main memory.

The data cache selecting device 350 may receive the critical section entrance signal CSES, and may select the critical section data cache 360 or the first-level data cache 370 as a data cache to be accessed by the processor core 300a. In some embodiments, if the processor core 300a enters the critical section, the data cache selecting device 350 may generate a data critical section miscount by counting a data request resulting in a tag miss and a valid cache line, and may determine a data cache phase of the critical section based on the data critical section miscount. The data cache selecting device 350 may select the critical section data cache 360 or the first-level data cache 370 based on the determined data cache phase of the critical section.

The data cache selecting device 350 may include a data cache phase detector 353 and a data cache selector 351. The data cache phase detector 353 may receive a data tag miss signal DTMS and a data cache line valid signal DVS from the critical section data cache 360, and may increase the data critical section miscount when both of the data tag miss signal DTMS and the data cache line valid signal DVS have high levels. The data cache phase detector 353 may generate a data cache phase change signal DCPCS indicating that the data cache phase of the critical section is changed if the data critical section miscount is greater than a reference value.

In a case where a tag corresponding to a data request does not exist in the critical section data cache 360 (i.e., in case of a tag miss), a cache miss may occur although a cache line corresponding to the data request is valid. The cache miss caused by the tag miss may occur when the processor core 300a executes the program code not corresponding to the critical section. Thus, when the cache miss caused by the tag miss occurs, the data cache phase of the critical section may be determined to be changed. The data cache phase detector 353 according to example embodiments may count the data request resulting in the tag miss and the valid cache line based on the data tag miss signal DTMS and the data cache line valid signal DVS, thereby accurately detecting the change of the data cache phase of the critical section.

The data cache selector 351 may select the critical section data cache 360 as the data cache to be accessed by the processor core 300a in response to the critical section entrance signal CSES. For example, if the critical section data cache 360 is selected by the data cache selector 351, the processor core 300a may check whether valid data corresponding to the data request exists in the critical section data cache 360. If the valid data exists in the critical section data cache 360 (i.e., in case of a tag hit and a valid cache line), the processor core 300a may fetch the data from the critical section data cache 360. If the valid data does not exist in the critical section data cache 360, the processor core 300a may fetch the data from the first-level data cache 370, another cache (e.g., the second-level cache or the third-level cache), or the main memory.

The critical section data cache 360 may have a size smaller than that of the first-level data cache 370, and may store data corresponding to the critical section. The data corresponding to the critical section may be repeatedly executed with a temporal locality. Accordingly, after the processor core 300a enters the critical section, the processor core 300a may use the critical section data cache 360 storing the data having the temporal locality, thereby increasing a hit rate for data requests from the processor core 300a. Further, since the processor core 300a uses the critical section data cache 360 having the size smaller than that of the first-level data cache 370, power consumption of the processor core 300a may be reduced.

If the data cache phase of the critical section is changed, the data cache selector 351 may receive the data cache phase change signal DCPCS from the data cache phase detector 353, and may select the first-level data cache 370 as the data cache to be accessed by the processor core 300a. For example, if the first-level data cache 370 is selected by the data cache selector 351, the processor core 300a may check whether the valid data corresponding to the data request exists in the first-level data cache 370. If the valid data exists in the first-level data cache 370, the processor core 300a may fetch the data from the first-level data cache 370. If the valid data does not exist in the first-level data cache 370, the processor core 300a may fetch the data from another cache (e.g., the second-level cache or the third-level cache) or the main memory.

As described above, in one or more embodiments, a processor core, e.g., 300a, may access a critical section instruction/data cache, e.g., 330, 360, and instructions/data may be stored with temporal locality after the entrance to the critical section, such that the instructions/data may be fetched with a high hit rate. Further, in one or more embodiments, since the processor core 300a may access the critical section instruction/data cache 330, 360 having a relatively small size before accessing the first-level instruction/data cache, e.g., 340, 370, power consumption of the processor core 300a may be reduced. In addition, in one or more embodiments, since the processor core 300a may access the critical section instruction/data cache 330, 360 using an instruction/data cache phase detector 323, 353, the critical section instruction/data cache 330 and 360 may be efficiently used with the high hit rate.

Although not illustrated in FIG. 3, the processor core 300a may be coupled to the second-level cache and/or the third-level cache, which may be located inside or outside the processor core 300a. For example, the processor core 300a may include a unified second-level cache in which both of the instruction and the data are stored. In such embodiments, e.g., the second-level cache may have a size larger than that of the first-level instruction cache 340 and the first-level data cache 370. The second-level cache may be accessed by the processor core 300a when the valid instruction does not exist in the critical section instruction cache 330 or in the first-level instruction cache 340, and/or when the valid data does not exist in the critical section data cache 360 and in the first-level data cache 370. More particularly, e.g., the processor core 300a may be coupled to the third-level cache located, e.g., outside the processor core 300a, and the third-level cache may have a size larger than that of the second-level cache. In some embodiments, the processor core 300a may be further coupled to a main memory, e.g., a memory module.

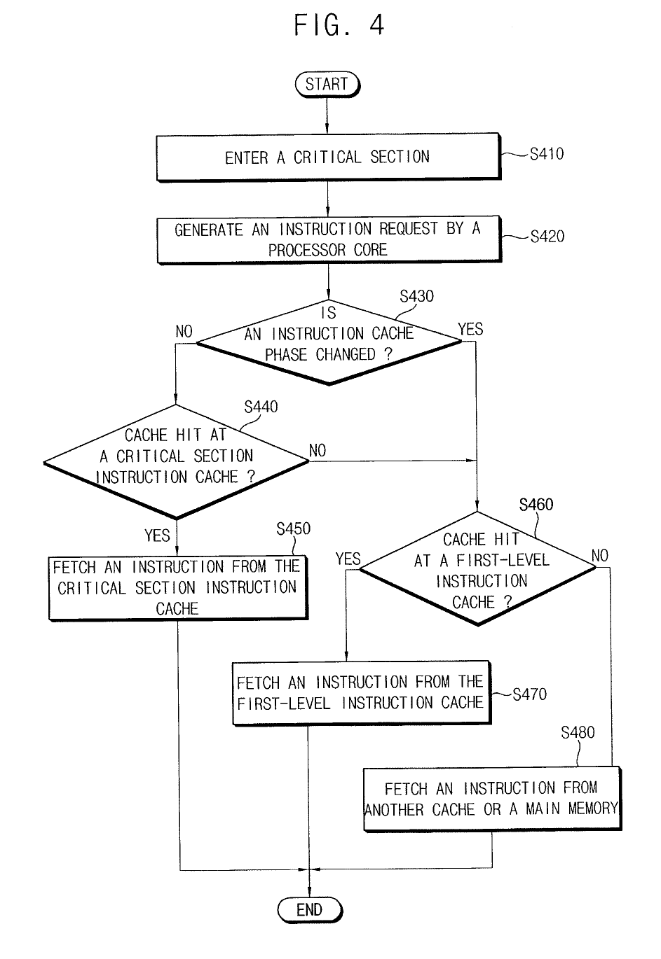

FIG. 4 illustrates a flow chart of an exemplary embodiment of a method of fetching an instruction in the processor core 300a of FIG. 3.

Referring to FIGS. 3 and 4, if a processor core 300a enters a critical section, the critical section detector 310 may provide a critical section entrance signal CSES to an instruction cache selecting device 320 (S410). The instruction cache phase detector 323 may perform a counting operation in response to the critical section entrance signal CSES. The processor core 300a may generate an instruction request (S420).

Before an instruction cache phase of the critical section is changed (S430:NO), or before the instruction cache phase detector 323 generates an instruction cache phase change signal ICPCS, an instruction cache phase selector 321 may select a critical section instruction cache 330 as an instruction cache to be accessed by the processor core 300a. If the critical section instruction cache 330 is selected, the processor core 300a may check whether a valid instruction corresponding to the instruction request exists in the critical section instruction cache 330 (S440). If the valid instruction exists in the critical section instruction cache 330 (i.e., in case of a cache hit) (S440:YES), the processor core 300a may fetch the instruction from the critical section instruction cache 330 (S450).

If the valid instruction does not exist in the critical section instruction cache 330 (i.e., in case of a cache miss) (S440:NO), the processor core 300a may check whether the valid instruction exists in a first-level instruction cache 340, which may have a larger size than that of the critical section instruction cache 330 (S460). Further, if the instruction cache phase of the critical section is changed (S430:YES), the instruction cache phase detector 323 may generate the instruction cache phase change signal ICPCS, and the instruction cache selector 321 may select the first-level instruction cache 340 as the instruction cache to be accessed by the processor core 300a in response to the instruction cache phase change signal ICPCS. Accordingly, the processor core 300a may access the first-level instruction cache 340 to check whether the valid instruction exists in the first-level instruction cache 340 (S460). If the valid instruction exists in the first-level instruction cache 340 (i.e., in case of a cache hit) (S460:YES), the processor core 300a may fetch the instruction from the first-level instruction cache 340 (S470).

If the valid instruction does not exist in the first-level instruction cache 340 (i.e., in case of a cache miss) (S460:NO), the processor core 300a may fetch the instruction from another cache (e.g., a second-level cache or a third-level cache) or a main memory having a size larger than the first-level instruction cache 340 (S480).

As described above, since the method of fetching the instruction in the processor core 300a according to example embodiments may use the critical section instruction cache 330 having a size smaller than that of the first-level instruction cache 340, power consumption of the processor core 300a may be reduced. Further, in one or more embodiments, the method of fetching the instruction in the processor core 300a may efficiently use the critical section instruction cache 330 with the high hit rate by using the instruction cache phase detector 323.

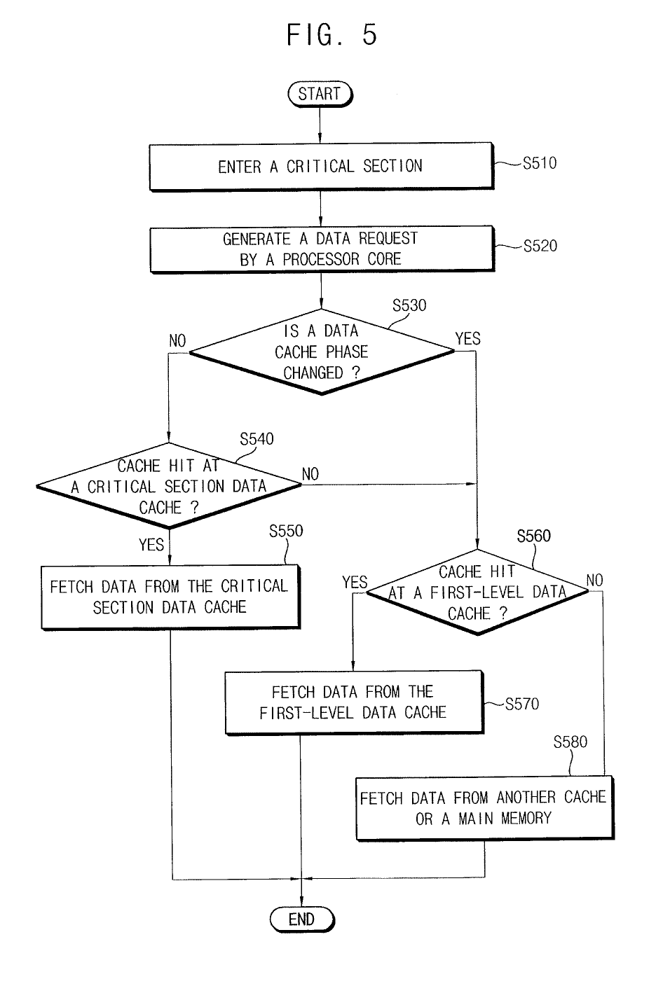

FIG. 5 illustrates a flow chart of an exemplary embodiment of a method of fetching data in the processor core 300a of FIG. 3.

Referring to FIGS. 3 and 5, if the processor core 300a enters a critical section, a critical section detector 310 may provide a critical section entrance signal CSES to a data cache selecting device 350 (S510). The data cache phase detector 353 may perform a counting operation in response to the critical section entrance signal CSES. The processor core 300a may generate a data request (S520).

Before a data cache phase of the critical section is changed (S530:NO), or before the data cache phase detector 353 generates a data cache phase change signal DCPCS, the data cache phase selector 351 may select a critical section data cache 360 as a data cache to be accessed by the processor core 300a. If the critical section data cache 360 is selected, the processor core 300a may check whether valid data corresponding to the data request exists in the critical section data cache 360 (S540). If the valid data exists in the critical section data cache 360 (i.e., in case of a cache hit) (S540:YES), the processor core 300a may fetch the data from the critical section data cache 360 (S550).

If the valid data does not exist in the critical section data cache 360 (i.e., in case of a cache miss) (S540:NO), the processor core 300a may check whether the valid data exists in a first-level data cache 370, which may have a larger size than that of the critical section data cache 360 (S560). Further, if the data cache phase of the critical section is changed (S530:YES), the data cache phase detector 353 may generate the data cache phase change signal DCPCS, and the data cache selector 351 may select the first-level data cache 370 as the data cache to be accessed by the processor core 300a in response to the data cache phase change signal DCPCS. Accordingly, the processor core 300a may access the first-level data cache 370 to check whether the valid data exists in the first-level data cache 370 (S560). If the valid data exists in the first-level data cache 370 (i.e., in case of a cache hit) (S560:YES), the processor core 300a may fetch the data from the first-level data cache 370 (S570).

If the valid data does not exist in the first-level data cache 370 (i.e., in case of a cache miss) (S560:NO), the processor core 300a may fetch the data from another cache (e.g., a second-level cache or a third-level cache) or a main memory having a size larger than the first-level data cache 370 (S580).

As described above, in one or more embodiments, since the method of fetching the data in the processor core 300a may use the critical section data cache 360 having a size smaller than that of the first-level data cache 370, power consumption of the processor core 300a may be reduced. Further, the method of fetching the data in the processor core 300a according to example embodiments may efficiently use the critical section data cache 360 with the high hit rate by using the data cache phase detector 353.

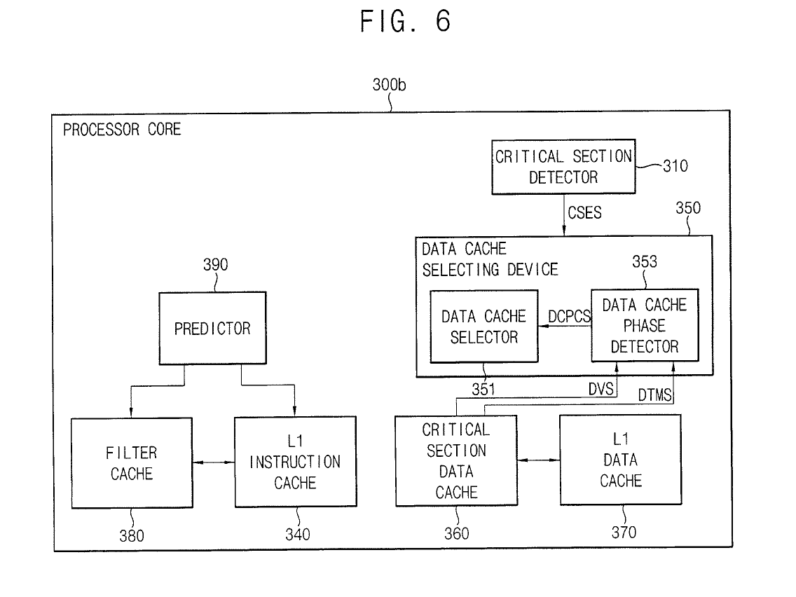

FIG. 6 illustrates a block diagram of another exemplary embodiment of a processor core 300b. In general, only differences between the exemplary processor core 300a of FIG. 3 and the exemplary processor core 300b of FIG. 6 will be described below.

Referring to FIG. 6, the processor core 300b may include the critical section detector 310, a predictor 390, a filter cache 380, the first-level instruction cache 340, the data cache selecting device 350, the critical section data cache 360, and the first-level L1 data cache 370. More particularly, relative to the processor core 300a of FIG. 3, the processor core 300b includes the predictor 390 and the filter cache 380 instead of the instruction cache selecting device 320 and the critical section instruction cache 330. In some embodiments, the processor core 300b may be included in a multi-core processor having a plurality of processor cores.

The critical section detector 310 may generate a critical section entrance signal

CSES by detecting an entrance to a critical section, and may provide the critical section entrance signal CSES to the data cache selecting device 350. The data cache selecting device 350 may determine a data cache phase of the critical section based on the critical section entrance signal CSES, and may select the critical section data cache 360 or the first-level data cache 370 as a data cache to be accessed by the processor core 300b according to the determined data cache phase. Since the critical section data cache 360 may have a size smaller than that of the first-level data cache 370, power consumption of the processor core 300b may be reduced.

The predictor 390 may predict whether a valid instruction corresponding to an instruction request exists in the filter cache 380, and may select the filter cache 380 or the first-level instruction cache 340 as an instruction cache to be accessed by the processor core 300b based on the prediction. The predictor 390 may employ at least one of various prediction techniques. In some embodiments, the predictor 390 may predict whether the valid instruction exists using a next fetch address prediction table (NFP) technique based on a temporal locality of a short loop. In some other embodiments, e.g., the predictor 390 may predict whether the valid instruction exists using a pattern prediction (PP) technique based on a 2-level adaptive branch prediction method.

If the filter cache 380 is selected by the predictor 390, the processor core 300b may check whether the valid instruction to be exists in the filter cache 380. If the valid instruction exists in the filter cache 380, the processor core 300b may fetch the instruction from the filter cache 380. If the valid instruction does not exist in the filter cache 380, the processor core 300b may fetch the instruction from the first-level L1 instruction cache 340, another cache (e.g., a second-level cache or a third-level cache), a main memory, etc. The filter cache 380 may have a size smaller than that of the first-level instruction cache 340. Accordingly, since the processor core 300b may first access the filter cache 380 having a small size, power consumption of the processor core 300b may be reduced. The filter cache 380 may store instructions as they are stored in the main memory, or may store fetched or decoded instructions.

If the first-level L1 instruction cache 340 is selected by the predictor 390, the processor core 300b may check whether the valid instruction exists in the first-level L1 instruction cache 340. If the valid instruction exists in the first-level L1 instruction cache 340, the processor core 300b may fetch the instruction from the first-level instruction cache 340. If the valid instruction does not exist in the first-level L1 instruction cache 340, the processor core 300b may fetch the instruction from another cache (e.g., the second-level cache or the third-level cache), the main memory, etc.

As described above, in one or more embodiments, since a processor core, e.g., 300b, accesses the critical section data cache 330 having a size smaller than that of the first-level data cache 370, and accesses the filter cache 380 having a size smaller than that of the first-level instruction cache 340, power consumption of the processor core 300b may be reduced.

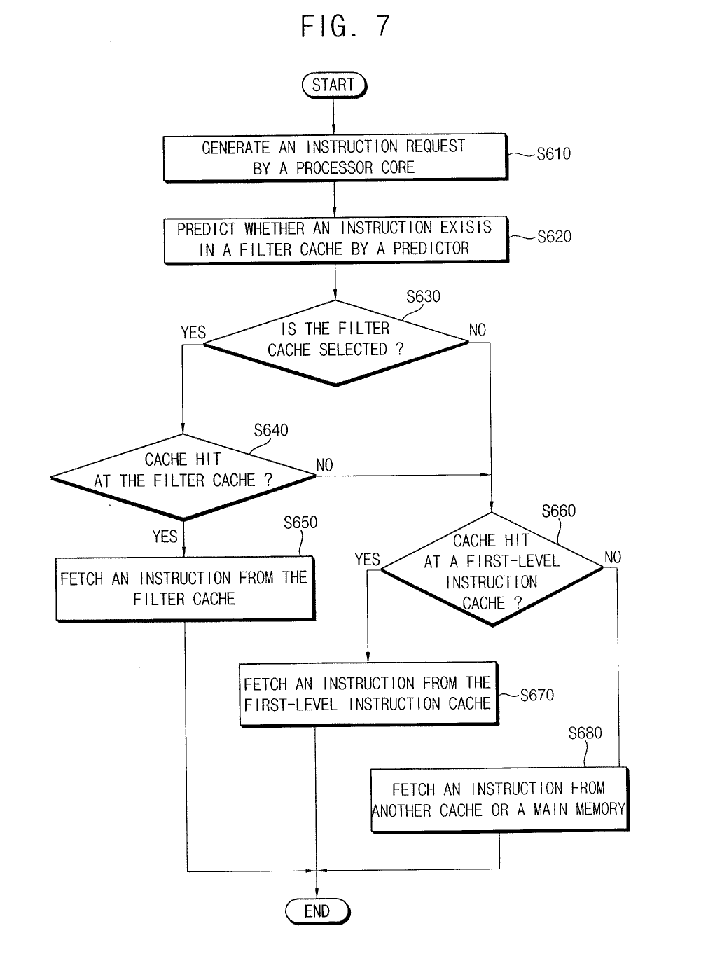

FIG. 7 illustrates a flow chart of an exemplary embodiment of a method of fetching an instruction in the processor core 300b of FIG. 6.

Referring to FIGS. 6 and 7, if the processor core 300b generates an instruction request (S610), the predictor 390 may predict whether a valid instruction corresponding to the instruction request exists in the filter cache 380 to select the filter cache 380 or the first-level instruction cache 340 as an instruction cache to be accessed by the processor core 300b (S620).

If the filter cache 380 is selected by the predictor 390 (S620:YES), the processor core 300b may check whether the valid instruction exists in the filter cache 380 (S640). If the valid instruction exists in the filter cache 380 (i.e., in case of a cache hit) (S640:YES), the processor core 300b may fetch the instruction from the filter cache 380 (S650).

If the valid instruction does not exist in the filter cache 380 (i.e., in case of a cache miss) (S640:NO), the processor core 300b may check whether the valid instruction exists in the first-level L1 instruction cache 340 having a size larger than that of the filter cache 380 (S660). If the valid instruction exists in the first-level L1 instruction cache 340 (i.e., in case of a cache hit) (S660:YES), the processor core 300b may fetch the instruction from the first-level L1 instruction cache 340 (S670).

If the valid instruction does not exist in the first-level instruction cache 340 (i.e., in case of a cache miss) (S660:NO), the processor core 300b may fetch the instruction from another cache (e.g., a second-level L2 cache or a third-level L3 cache). a main memory having a size larger than that of the first-level instruction cache 340, etc. (S680).

As described above, in one or more embodiments, since the method of fetching the instruction in the processor core 300b may use the filter cache 380 having a size smaller than that of the first-level instruction cache 340, power consumption of the processor core 300a may be reduced.

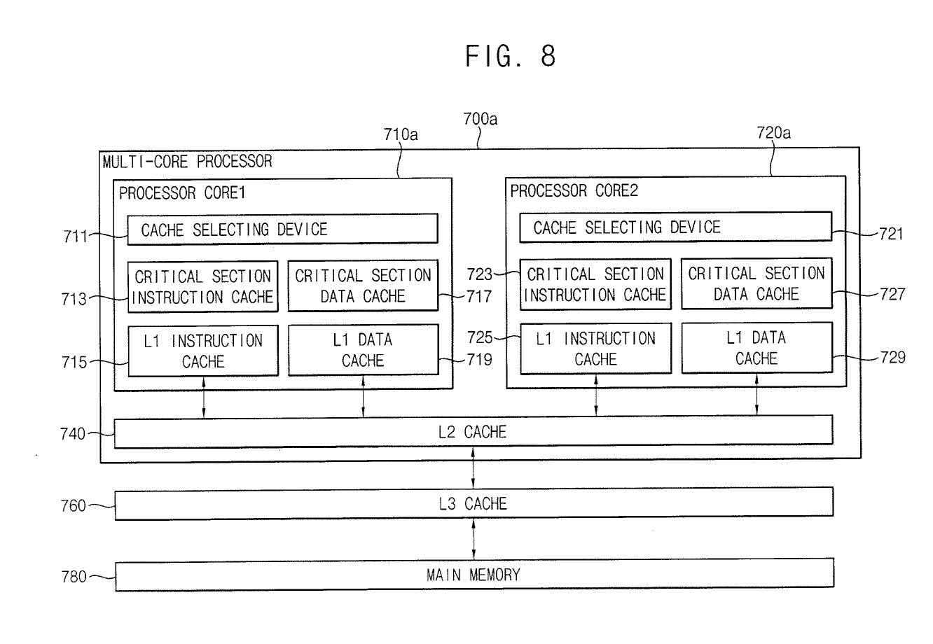

FIG. 8 illustrates a block diagram of an exemplary embodiment of a multi-core processor 700a.

Referring to FIG. 8, the multi-core processor 700a may include a first processor core 710a, a second processor core 720a, and a unified second-level cache 740. The multi-core processor 700a may be coupled to a third-level L3 cache 760 and a main memory 780. The third-level L3 cache 760 and the main memory 780 may each have sizes larger than that of the second-level L2 cache 740. Although FIG. 8 illustrates a dual-core processor 700a having two processor cores 710a, 720a, in some embodiments, the multi-core processor 700a may include three or more processor cores. For example, the multi-core processor 700a may be a quad-core processor, a hexa-core processor, etc.

Each processor core 710a, 720a may include a cache selecting device 711 and 721, a critical section instruction cache 713, 723, a first-level instruction cache 715, 725, a critical section data cache 717, 727, and a first-level data cache 719, 729. In some other embodiments, each processor core 710a, 720a may, e.g., include a filter cache instead of the critical section instruction cache 713, 723.

Before each processor core 710a, 720a enters a critical section, each processor core 710a, 720a may fetch an instruction from the first-level instruction cache 715, 725, and may fetch data from the first-level data cache 719, 729. If a cache miss occurs at the first-level instruction cache 715, 725 or the first-level L1 data cache 719, 729, each processor core 710a, 720a may fetch the instruction or the data from the second-level cache 740 having a size larger than that of the first-level L1 instruction cache 715, 725 and/or the first-level L1 data cache 719, 729. For example, in a case where the instruction is fetched from the second-level L2 cache 740 to the first processor core 710a, a cache line including the instruction in the second-level L2 cache 740 may be copied to the first-level L1 instruction cache 715, or may be exchanged for a cache line of the first-level instruction L1 cache 715. Thereafter, the first processor core 710a may fetch the instruction from the first-level instruction cache 715.

If a cache miss occurs at the second-level L2 cache 740, each processor core 710a and 720a may fetch the instruction or the data from the third-level L3 cache 760, which may have a larger size than that of the second-level L2 cache 740. For example, in a case where the instruction is fetched from the third-level L3 cache 760 to the first processor core 710a, a cache line including the instruction in the third-level L3 cache 760 may be copied or exchanged to the second-level L2 cache 740 and then to the first-level L1 instruction cache 715. Thereafter, the first processor core 710a may fetch the instruction from the first-level L1 instruction cache 715.

If a cache miss occurs at the third-level L3 cache 760, each processor core 710a and 720a may fetch the instruction or the data from the main memory 780, which may have a larger size than that of the third-level cache 760. For example, in a case where the instruction is fetched from the main memory 780 to the first processor core 710a, a line including the instruction in the main memory 780 may be copied or exchanged to the third-level L3 cache 760, to the second-level L2 cache 740 and then to the first-level L1 instruction cache 715. Thereafter, the first processor core 710a may fetch the instruction from the first-level L1 instruction cache 715.

After each processor core 710a, 720a enters the critical section, each processor core 710a, 720a may fetch an instruction from the critical section instruction cache 713, 723, and may fetch data from critical section data cache 717, 727. If a cache miss occurs at the critical section instruction cache 713, 723, each processor core 710a, 720a may fetch the instruction from the first-level instruction cache 715, 725 having a size larger than that of the critical section instruction cache 713, 723. If a cache miss occurs at the critical section data cache 717, 727, each processor core 710a, 720a may fetch the data from the first-level L1 data cache 719, 729 having a size larger than that of the critical section data cache 717, 729. If a cache miss occurs at the first-level instruction cache 715, 725 or the first-level L1 data cache 719, 729, each of the processor cores 710a, 720a may fetch the instruction or the data from the second-level L2 cache 740. If a cache miss occurs at the second-level L2 cache 740, each of the processor cores 710a, 720a may fetch the instruction or the data from the third-level L3 cache 760. Further, if a cache miss occurs at the third-level L3 cache 760, each of the processor cores 710a, 720a may fetch the instruction or the data from the main memory 780.

After the processor core 710a, 720a enters the critical section, if the processor core 710a, 720a executes instructions of a program code not corresponding to the critical section, or if an instruction cache phase of the critical section is changed, the processor core 710a, 720a may first access the first-level L1 instruction cache 715, 725 without accessing the critical section instruction cache 713, 723. Further, if the processor core 710a, 720a executes data of the program code not corresponding to the critical section, or if a data cache phase of the critical section is changed, the processor core 710a, 720a may first access the first-level L1 data cache 719, 729 without accessing the critical section data cache 717, 727. The cache selecting device 711, 721 may detect the change of the instruction cache phase and/or the data cache phase. For example, the cache selecting device 711, 721 may detect the change of the instruction cache phase by generating an instruction critical section miscount based on an instruction tag miss signal and an instruction cache line valid signal from the critical section instruction cache 713, 723, and may detect the change of the data cache phase by generating a data critical section miscount based on a data tag miss signal and a data cache line valid signal from the critical section data cache 717, 727.

In a case where a tag of the instruction exists in the critical section instruction cache 713, 723 and a cache line of the instruction is invalid, the cache selecting device 711, 721 may not increase the instruction critical section miscount although a cache miss occurs at the critical section instruction cache 713, 723. Further, in a case where a tag of the data exists in the critical section data cache 717, 727 and a cache line of the data is invalid, the cache selecting device 711, 721 may not increase the data critical section miscount although a cache miss occurs at the critical section data cache 717, 727. For example, the critical section data cache 717 of the first processor core 710a and the critical section data cache 727 of the second processor core 720a may store the same cache line. When the second processor core 720a generates a transaction for the cache line of the critical section data cache 727, the second processor core 720a may invalidate the cache line of the critical section data cache 717 of the first processor core 710a as well as the cache line of the critical section data cache 727 of the second processor core 720a. In this case, although a cache miss occurs at the critical section data cache 717 of the first processor core 710a, the first processor core 710a may execute a program code corresponding to the critical section, and the cache selecting device 711 of the first processor core 710a may not increase the data critical section miscount. Accordingly, since the cache selecting device 711, 721 does not increase the critical section miscount while each of the processor cores 710a, 720a executes the program code corresponding to the critical section, the cache selecting device 711, 721 may accurately detect the change of the data cache phase and/or the change of the instruction cache phase.

As described above, in one or more embodiments, the multi-core processor 700a may fetch the instruction/data with a high hit rate using the critical section instruction/data cache 713, 717, 723, 727, and may reduce power consumption.

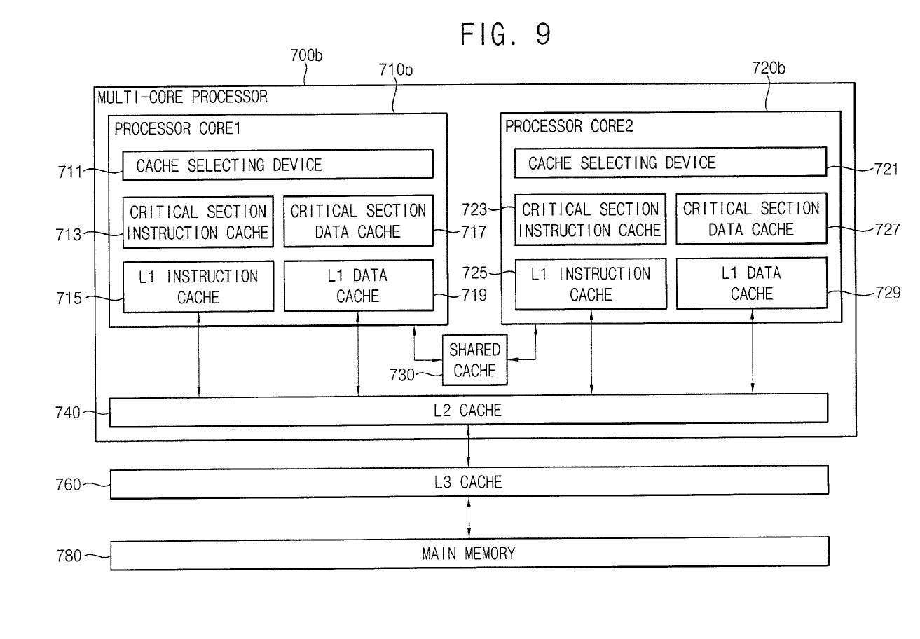

FIG. 9 illustrates a block diagram of another exemplary embodiment of a multi-core processor 700b. In general, only differences between the exemplary multi-core processor 700a of FIG. 8 and the exemplary multi-core processor 700b of FIG. 9 will be described below.

Referring to FIG. 9, the multi-core processor 700b may include the first processor core 710b, the second processor core 720b, the second-level L2 cache 740, and a shared cache 730. The multi-core processor 700b may be coupled to the third-level L3 cache 760 and a main memory 780 having a size larger than that of the second-level cache 740. Compared to the multi-core processor 700a of FIG. 7, the multi-core processor 700b may further include the shared cache 730.

The shared cache 730 may be shared by the first processor core 710b and the second processor core 720b. The shared cache 730 may store an instruction/data that is commonly used by the first processor core 710b and the second processor core 720b. For example, in a case where the second processor core 720b generates a transaction for a cache line of the critical section data cache 727, a corresponding cache line of the critical section data cache 717 included in the first processor core 710 may be invalidated, and a valid cache line corresponding to the cache line of the critical section data cache 717 included in the first processor core 710b and the cache line of the critical section data cache 727 included in the second processor core 720b may be written to the shared cache 730. After the valid cache line is stored in the shared cache 730, the first processor core 710b and the second processor core 720b may fetch data to be executed from the valid cache line stored in the shared cache 730. In some example embodiments, the multi-core processor 700b may use a modified exclusive shared invalid (MESI) protocol.

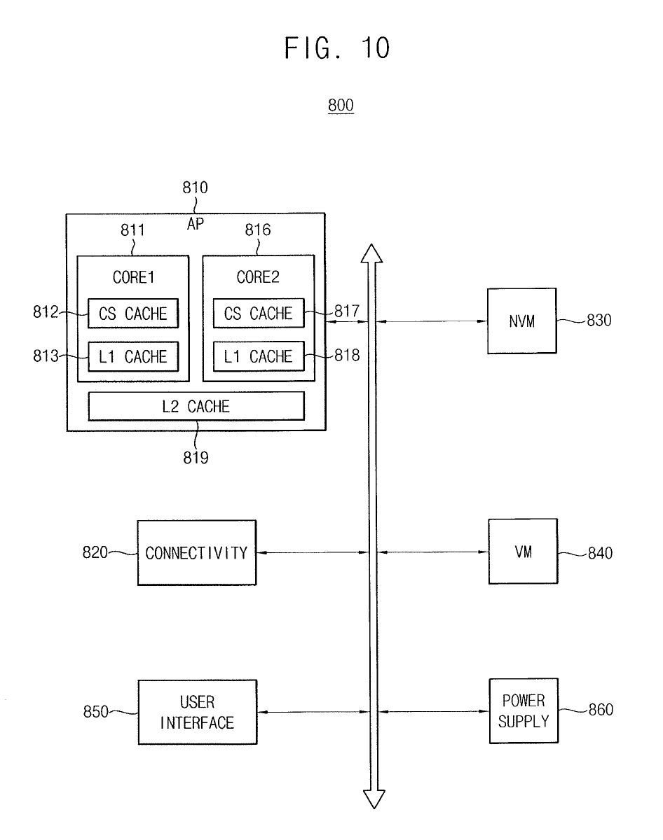

FIG. 10 illustrates a block diagram of an exemplary embodiment of a mobile system 800.

Referring to FIG. 10, the mobile system 800 may include an application processor 810, a connectivity unit 820, a nonvolatile memory device 830, a volatile memory device 840, a user interface 850, and a power supply 860. In one or more embodiments, the mobile system 800 may be any mobile system, e.g., a mobile phone, a smart phone, a tablet computer, a laptop computer, a personal digital assistant (PDA), a portable multimedia player (PMP), a digital camera, a portable game console, a music player, a camcorder, a video player, a navigation system, etc.

The application processor 810 may include a first processor core 811, a second processor core 816, and a second-level L2 cache 819. Each of the processor cores 811, 816 may execute applications, such as an internet browser, a game application, a video player application, etc. Each of the processor cores 811, 816 may include a critical section cache 812, 817, and a first-level cache 813, 818. If the processor core 811, 816 enters a critical section, the processor core 811, 816 may first access the critical section cache 812, 817. Each of the processor cores 811, 816 may accurately detect a change of a cache phase of the critical section. Thus, each of the processor cores 811, 816 may use the critical section cache 812, 817 with a high hit rate. Further, since a size of the critical section cache 812, 817 may be smaller than that of the first-level L1 cache 813, 818, each of the processor cores 811, 816 may reduce power consumption by using the critical section cache 812, 817 having the relatively smaller size. The processor core 811, 816 may access the first-level L1 cache 813, 818 if a cache miss occurs at the critical section cache 812, 817, may access the second-level L2 cache 819 if a cache miss occurs at the first-level cache 813, 818, and may access the volatile memory device 810 if a cache miss occurs at the second-level L2 cache 819. In some embodiments, e.g., the application processor 810 may be coupled to a third-level L3 cache and/or a fourth-level L4 cache, which may be located inside or outside the application processor 810.

The connectivity unit 820 may communicate with an external device. For example, the connectivity unit 820 may perform a USB communication, an Ethernet communication, a near field communication (NFC), a radio frequency identification (RFID) communication, a mobile telecommunication, a memory card communication, etc.

The nonvolatile memory device 830 may store a boot image for booting the mobile system 800. For example, the nonvolatile memory device 830 may include an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), or the like.

The volatile memory device 840 may store an instruction/data processed by the application processor 810, or may serve as a working memory. For example, the volatile memory device 840 may include a dynamic random access memory (DRAM), a static random access memory (SRAM), a mobile DRAM, or the like.

The user interface 850 may include at least one input device, such as a keypad, a touch screen, etc., and at least one output device, such as a display device, a speaker, etc. The power supply 860 may supply the mobile system 800 with power. In some embodiments, e.g., the mobile system 800 may further include a camera image processor (CIS), and a modem, such as a baseband chipset. For example, the modem may be a modem processor that supports at least one of various communications, such as GSM, GPRS, WCDMA, HSxPA, etc.

In one or more embodiments, the mobile system 800 and/or components of the mobile system 800 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

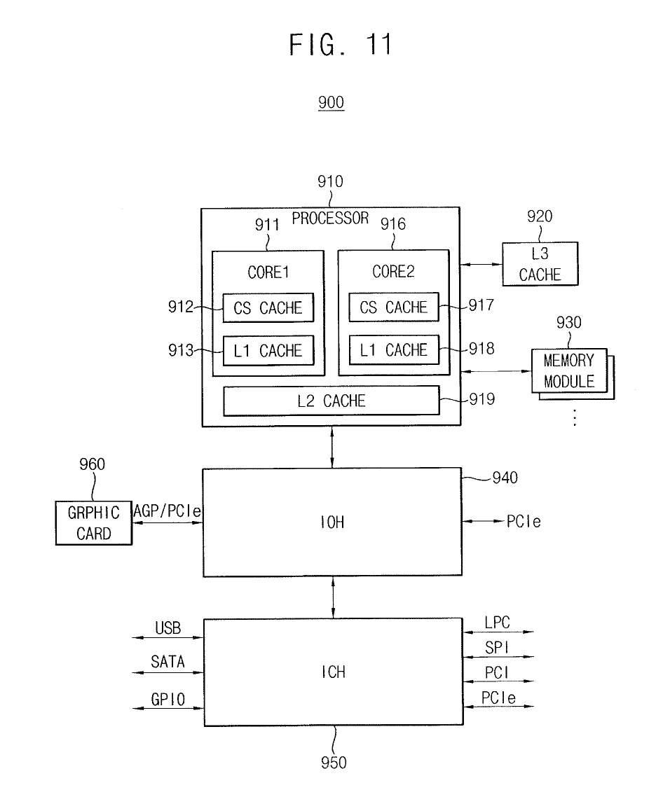

FIG. 11 illustrates a block diagram of an exemplary embodiment of a computing system 900.

Referring to FIG. 11, the computing system 900 may include a processor 910, a third-level cache 920, at least one memory module 930, an input/output hub 940, an input/output controller hub 950, and a graphic card 960. In one or more embodiments, the computing system 900 may be any computing system, such as a personal computer (PC), a server computer, a workstation, a tablet computer, a laptop computer, a mobile phone, a smart phone, a personal digital assistant (PDA), a portable multimedia player (PMP), a digital camera, a digital television, a set-top box, a music player, a portable game console, a navigation device, etc.

The processor 910 may perform specific calculations or tasks. For example, the processor 910 may be a microprocessor, a central process unit (CPU), a digital signal processor, or the like. The processor 910 may include a first processor core 911, a second processor core 916, and a second-level L2 cache 919. Each of the processor cores 911, 916 may include a critical section cache 912, 917, and a first-level cache 913, 918. If the processor core 911, 916 enters a critical section, the processor core 911 and 916 may first access the critical section cache 912, 917. Each of the processor cores 911, 916 may accurately detect a change of a cache phase of the critical section. Thus, each processor core 911, 916 may use the critical section cache 912, 917 with a high hit rate. Further, since a size of the critical section cache 912, 917 may be smaller than that of the first-level L1 cache 913, 918, the processor core 911, 916 may reduce power consumption by using the critical section cache 912, 917 having the relatively smaller size. Each of the processor cores 911, 916 may access the first-level L1 cache 913 and 918 if a cache miss occurs at the critical section cache 912, 917, may access the second-level L2 cache 919 if a cache miss occurs at the first-level L1 cache 913, 918, may access the third-level L3 cache 920 if a cache miss occurs at the second-level cache 919, and may access the memory module 930 if a cache miss occurs at the third-level L3 cache 920. Although FIG. 11 illustrates an example where the third-level cache 920 is located outside the processor 910, in some embodiments, the third-level cache 920 may be located inside the processor 910. Further, e.g., the processor 910 may be further coupled to additional cache levels, e.g., a fourth-level cache L4, located inside or outside the processor 910. Although FIG. 11 illustrates an example of the computing system 900 including the single processor 910, in some embodiments, the computing system 900 may include more than one processor.

The processor 910 may include a memory controller (not shown) that controls an operation of the memory module 930. In such embodiments, the memory controller included in the processor 910 may be referred to as an integrated memory controller (IMC). A memory interface between the memory controller and the memory module 930 may be implemented by one channel including a plurality of signal lines, or by a plurality of channels. Each channel may be coupled to at least one memory module 930. In some example embodiments, the memory controller may be included in the input/output hub 940. The input/output hub 940 including the memory controller may be referred to as a memory controller hub (MCH).

The input/output hub 940 may manage data transfer between the processor 910 and devices, such as the graphic card 960. The input/output hub 940 may be coupled to the processor 910 via at least one of various interfaces, such as a front side bus (FSB), a system bus, a HyperTransport, a lightning data transport (LDT), a QuickPath interconnect (QPI), a common system interface (CSI), etc. Although FIG. 11 illustrates an example of the computing system 900 including the single input/output hub 940, in some embodiments, the computing system 900 may include a plurality of such input/output hubs.

The input/output hub 940 may provide various interfaces with devices. For example, the input/output hub 940 may provide an accelerated graphics port (AGP) interface, a peripheral component interface-express (PCIe), a communications streaming architecture (CSA) interface, etc.

The graphic card 960 may be coupled to the input/output hub 940 via the AGP or the PCIe. The graphic card 960 may control a display device (not shown) for displaying an image. The graphic card 960 may include an internal processor and an internal memory to process the image. In some embodiments, the input/output hub 940 may include an internal graphic device along with or instead of the graphic card 960. The internal graphic device may be referred to as an integrated graphics, and an input/output hub including the memory controller and the internal graphic device may be referred to as a graphics and memory controller hub (GMCH).

The input/output controller hub 950 may perform data buffering and interface arbitration to efficiently operate various system interfaces. The input/output controller hub 950 may be coupled to the input/output hub 940 via an internal bus. For example, the input/output controller hub 950 may be coupled to the input/output hub 940 via at least one of various interfaces, such as a direct media interface (DMI), a hub interface, an enterprise Southbridge interface (ESI), PCIe, etc. The input/output controller hub 950 may provide various interfaces with peripheral devices. For example, the input/output controller hub 950 may provide a universal serial bus (USB) port, a serial advanced technology attachment (SATA) port, a general purpose input/output (GPIO), a low pin count (LPC) bus, a serial peripheral interface (SPI), a PCI, a PCIe, etc.

In some embodiments, the processor 910, the input/output hub 940 and the input/output controller hub 950 may be implemented as separate chipsets or separate integrated circuits. In other embodiments, e.g., at least two of the processor 910, the input/output hub 940 and the input/output controller hub 950 may be implemented as one chipset.

As described above, in one or more embodiments, a processor, e.g., 910, may reduce power consumption and/or may operate at higher speed using a critical section cache, e.g., 912, 917.

The foregoing is illustrative of exemplary embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A cache phase detector included in a processor core, the cache phase detector comprising:
a counting unit configured to generate a critical section miscount by counting a request from the processor core resulting in a tag miss and a valid cache line based on a tag miss signal and a cache line valid signal, the tag miss signal indicating that a tag corresponding to the request does not exist in a critical section cache, and the cache line valid signal indicating that a cache line of the critical section cache corresponding to the request is valid; and
a signal generating unit configured to compare the critical section miscount from the counting unit with a reference value, and configured to generate a cache phase change signal if the critical section miscount is greater than the reference value, the cache phase change signal indicating that a cache phase of a critical section performed by the processor core is changed.

2. The cache phase detector as claimed in claim 1, wherein the counting unit is configured to receive a critical section entrance signal indicating that the processor core enters the critical section from a critical section detector included in the processor core, and is configured to initialize the critical section miscount in response to the critical section entrance signal.

3. The cache phase detector as claimed in claim 1, wherein the counting unit comprises:
an AND gate configured to perform an AND operation on the tag miss signal and the cache line valid signal; and
a counter configured to increase the critical section miscount in response to an output signal of the AND gate.

4. The cache phase detector as claimed in claim 1, wherein the signal generating unit comprises:
a register configured to store the reference value; and
a comparator configured to generate the cache phase change signal by comparing the critical section miscount from the counting unit with the reference value from the register.

5. A processor core included in a multi-core processor, the processor core comprising:
a first-level data cache;
a critical section data cache having a size smaller than that of the first-level data cache; and
a data cache selecting device configured to generate a data critical section miscount by counting a data request from the processor core resulting in a tag miss and a valid cache line, configured to determine a data cache phase of the critical section data cache based on the data critical section miscount, and configured to select, as a data cache to be accessed by the processor core, the critical section data cache or the first-level data cache according to the determined data cache phase.

6. The processor core as claimed in claim 5, wherein the processor core is configured to check whether a valid data corresponding to the data request exists in the critical section data cache when the critical section data cache is selected by the data cache selecting device, and
wherein the processor core is configured to fetch the valid data from the critical section data cache when the valid data exists in the critical section data cache, and is configured to fetch the valid data from the first-level data cache, another cache or a main memory if the valid data does not exist in the critical section data cache.

7. The processor core as claimed in claim 5, wherein the processor core is configured to check whether a valid data corresponding to the data request exists in the first-level data cache when the first-level data cache is selected by the data cache selecting device, and
wherein the processor core is configured to fetch the valid data from the first-level data cache when the valid data exists in the first-level data cache, and is configured to fetch the valid data from another cache or a main memory when the valid data does not exist in the first-level data cache.

8. The processor core as claimed in claim 5, wherein the data cache selecting device comprises:
a data cache phase detector configured to generate the data critical section miscount by counting the data request resulting in the tag miss and the valid cache line based on a data tag miss signal and a data cache line valid signal, and configured to generate a data cache phase change signal based on the data critical section miscount, the data cache phase change signal indicating that the data cache phase is changed; and
a data cache selector configured to determine the data cache phase based on the data cache phase change signal, and configured to select the critical section data cache or the first-level data cache according to the determined data cache phase.

9. The processor core as claimed in claim 5, further comprising:
a first-level instruction cache;
a critical section instruction cache having a size smaller than that of the first-level instruction cache; and
an instruction cache selecting device configured to generate an instruction critical section miscount by counting an instruction request from the processor core resulting in a tag miss and a valid cache line, configured to determine an instruction cache phase of the critical section instruction cache based on the instruction critical section miscount, and configured to select, as an instruction cache to be accessed by the processor core, the critical section instruction cache or the first-level instruction cache according to the determined instruction cache phase.

10. The processor core as claimed in claim 9, wherein the processor core is configured to check whether a valid instruction corresponding to the instruction request exists in the critical section instruction cache when the critical section instruction cache is selected by the instruction cache selecting device, and
wherein the processor core is configured to fetch the valid instruction from the critical section instruction cache when the valid instruction exists in the critical section instruction cache, and is configured to fetch the valid instruction from the first-level instruction cache, another cache or a main memory when the valid instruction does not exist in the critical section instruction cache.

11. The processor core as claimed in claim 9, wherein the processor core is configured to check whether a valid instruction corresponding to the instruction request exists in the first-level instruction cache when the first-level instruction cache is selected by the instruction cache selecting device, and
wherein the processor core is configured to fetch the valid instruction from the first-level instruction cache when the valid instruction exists in the first-level instruction cache, and is configured to fetch the valid instruction from another cache or a main memory if the valid instruction does not exist in the first-level instruction cache.

12. The processor core as claimed in claim 9, further comprising:
a critical section detector configured to generate a critical section entrance signal by detecting that the processor core enters the critical section, and configured to provide the critical section entrance signal to the data cache selecting device and the instruction cache selecting device.

13. The processor core as claimed in claim 9, further comprising:
a second-level cache having a size greater than those of the first-level data cache and the first-level instruction cache,
wherein the processor core is configured to access the second-level cache when a valid data corresponding to the data request exists neither in the critical section data cache nor in the first-level data cache, and is configured to access the second-level cache when a valid instruction corresponding to the instruction request exists neither in the critical section instruction cache nor in the first-level instruction cache.

14. The processor core as claimed in claim 5, further comprising:
a first-level instruction cache;
a filter cache having a size smaller than that of the first-level instruction cache; and
a predictor configured to select, as an instruction cache to be accessed by the processor core, the filter cache or the first-level instruction cache by predicting whether a valid instruction corresponding to an instruction request from the processor core exists in the filter cache.

15. The processor core as claimed in claim 14, wherein the processor core is configured to check whether the valid instruction exists in the filter cache if the filter cache is selected by the predictor, and
wherein the processor core is configured to fetch the valid instruction from the filter cache if the valid instruction exists in the filter cache, and is configured to fetch the valid instruction from the first-level instruction cache, another cache or a main memory if the valid instruction does not exist in the filter cache.

16. A critical section cache selector included in a processor core including a critical section cache and at least one n-level cache, the cache selector comprising:
a cache phase detector configured to determine a cache phase of the critical section cache based on a critical section miss signal generated based on tag miss signals and valid cache line signals generated in response to requests from the processor core, and to select the critical section cache or the at least one n-level cache based on the critical section miss signal, where n is an integer greater than or equal to 1.

17. The critical section cache selector as claimed in claim 16, wherein the critical section cache is a critical section data cache and each of the n-level caches is an n-level data cache.

18. The critical section cache selector as claimed in claim 16, wherein the critical section cache is a critical section instruction cache and each of the n-level caches is an n-level instruction cache.

19. The critical section cache selector as claimed in claim 16, wherein the cache phase detector includes a counter configured to generate the critical section miss signal by counting respective ones of the requests from the processor core resulting in the tag miss signals and the valid cache line signals.

20. The critical section cache selector as claimed in claim 19, wherein the cache phase detector is configured to compare the critical section miss signal with a reference signal, and to generate a cache phase change signal indicating that a phase of the critical section cache is changed if the critical section miss signal has a value greater than a value of the reference signal.
